(19) United States
(12) Patent Application Publication
(10) Pub. No.: US 2011/0289316 A1
(43) Pub. Date: Nov. 24, 2011

(54) USER AUTHENTICATION

(75) Inventors: Ronan CREMIN, Dublin (IE); Hamish GRAHAM, Dublin (IE); Bartosz JABLONSKI, Dublin (IE); Tomas TRNKA, Dublin (IE)

(73) Assignee: MTLD TOP LEVEL DOMAIN LIMITED, Dublin (IE)

(21) Appl. No.: 12/783,424

(22) Filed: May 19, 2010

(51) Int. Cl. H04L 9/32

(52) U.S. Cl. 713/168

(57) ABSTRACT

Embodiments of the present invention relate to a method and system in which a URI is signed using a private key (PKI), and the signed URI is sent to a second server where the signature is validated using the public key.

### FIELD OF THE INVENTION

The present invention relates the authentication of a user. In particular, but not exclusively, the invention relates to the delivery of content over the internet from an originating server to a user based on authentication of the user by an intermediary server.

### BACKGROUND TO THE INVENTION

It is increasingly common for services to be provided to users over the internet. Often, some aspect of the service needs to be kept confidential. For example, when a person purchases goods or services over the internet, the organisation selling the goods or services has a need to identify the person purchasing the goods or services and to receive payment from them. The organisation also has a need to store at least the identity of the person in order to be able to provide the purchased goods or services at a later date, e.g. to post goods to the correct address or allow the person to access services, such as banking or email, provided over the internet.

Typically, in order to identify a person over the internet, the web server of an organisation provides a web page to the person's computer, which web page includes a form that can be populated with the person's identification details, such as their email address, home address, telephone number and such like. The form typically includes fields in which the person can enter a username and password. The information provided in the form is returned to the web server for verification. For example, an email may be sent to the email address provided in the form including a link to a further web page provided by the web server. The further web page usually includes a form allowing further information to be provided by the person, and the web server can check that this further information corresponds with information already provided to the web server by the person in order to verify that the email address is that of the person identified in the earlier from. During this process, the web server stores the username and password provided to it and the person remembers the user name and password. In subsequent transactions, the web server can then authenticate the person by providing a web page that allows the person to provide the username and password. The process of indentifying a person is often referred to as “registration” and, once the process has been completed, the person may be referred to as a “registered user”.

The registration process is time consuming and people tend be reluctant to complete registration processes with multiple organisations. For example, people can find it difficult to remember large numbers of usernames and passwords registered with different organisations. Moreover, people are wary of providing their personal information, and in particular details of payment cards, to multiple organisations, as they are concerned that the information may be misused by the organisations, e.g. that they may receive unwanted or “spam” email, or that the information may be used fraudulently.

It has been suggested to centralise certain aspects of the identification of persons purchasing goods and services. For example, some organisations do not handle the registration process themselves. Rather, if a person wishes to purchase goods or services using an organisations website, the website re-directs the person to that website of a centralised registration system. The centralised registration system authenticates the person, using previously provided registrations details, and then re-directs the person back to the organisation's website. If many organisations use the centralised registration system, it can improve convenience for the user. However, re-directing the user from one website to another and back again can be confusing for the user and having to deal with two organisations is not reassuring.

The present invention seeks to address these problems.

### SUMMARY OF THE INVENTION

According to a first aspect of the present invention, there is provided an apparatus for delivering content to a user, the apparatus comprising:

a first server configured to
authenticate the user,
receive a request from the user for a web resource,
generate a uniform resource identifier, at least part of which is signed

using a private key of a public/private key pair, and
deliver the web resource to the user, the web resource including the uniform resource identifier; and

a second server configured to
receive a request from the user for the content, the request including the uniform resource identifier,
verify using the public key of the public/private key pair that the at least part of the uniform resource identifier was signed using the private key of the public/private key pair, and
deliver the content to the user in response to the request only if the uniform resource identifier is so verified.

According to a second aspect of the present invention, there is provided a method of delivering content to a user, the method comprising:

at a first server
authenticating the user,
receiving a request from the user for a web resource,
generating a uniform resource identifier, at least part of which is signed using a private key of a public/private key pair, and
delivering the web resource to the user, the web resource including the uniform resource identifier; and

at a second server
receiving a request from the user for the content, the request including the uniform resource identifier,
verifying using the public key of the public/private key pair that the at least part of the uniform resource identifier was signed using the private key of the public/private key pair, and
delivering the content to the user in response to the request only if the uniform resource identifier is so verified.

So, the present invention allows a user to be authenticated by a first server and provided with a uniform resource identifier which can be used to request content from a second server. As the uniform resource identifier is at least in part signed by a private key, the second server is able to verify that authentication has taken place before delivering the content to the user. In this manner, the present invention can obviate any requirement for the second server to authenticate the user itself.

Preferably, the web resource comprises a web page and the content is delivered to the user as part of the web page. For example, the content may be delivered within an IFRAME of the web page. This provides a convenient and user-friendly approach by which the content can be presented to the user. Alternatively, the content may be delivered in an additional web resource, such as a web page, separate to that delivered to the user by the first server.

In preferred embodiments, the content delivered to the user includes an additional uniform resource identifier and the second server is configured to

receive an additional request from the user for additional content, the additional request including the additional uniform resource identifier, and

deliver the additional content to the user in response to the additional request.

Preferably, the content delivered to the user includes an additional uniform resource identifier and the second server is configured to

receive an additional request from the user relating to a service controlled by the second server, the additional request including the additional uniform resource identifier, and

alter control of the service in response to the additional request.

The user is able to interact with the content provided by the second server in this manner. This allows the content to be used to control a service provided to the user.

In preferred embodiments, the apparatus is additionally for delivering the content to another user, and comprises

one or more additional first servers, each additional first server being associated with a respective public/private key pair and configured to
authenticate the other user,
receive a request from the other user for a web resource,
generate a uniform resource identifier, at least part of which is signed using the private key of a public/private key pair with which the additional first server is associated, and
deliver the web resource to the other user, the web resource including the uniform resource identifier; and a second server configured to
receive a request from the other user for the content, the request including the uniform resource identifier,
verify using the public key of the public/private key pair with which the additional first server is associated that the at least part of the uniform resource identifier was signed using the private key of the public/private key pair, and
deliver the content to the other user in response to the request only if the uniform resource identifier is so verified.

Similarly, the method may be additionally for delivering the content to another user, and may further comprise:

at one or more additional first servers, each being associated with a respective public/private key pair,
authenticating the other user,
receiving a request from the other user for a web resource,
generating a uniform resource identifier, at least in part of which is signed using the private key of a public/private key pair with which the additional first server is associated, and
delivering the web resource to the other user, the web resource including the uniform resource identifier; and

at the second server
receiving a request from the other user for the content, the request including the uniform resource identifier,
verifying using the public key of the public/private key pair with which the additional first server is associated that the at least part of the uniform resource identifier was signed using the private key of the public/private key pair, and
delivering the content to the other user in response to the request only if the uniform resource identifier is so verified.

So, the second server may use authentication carried out by different first servers in providing content to users. This means the second server may benefit from relationships established between users and a number of first servers, allowing the content to be delivered to a greater number of users than would otherwise be possible.

Preferably, the uniform resource identifier includes a unique element and the second server comprises a memory for storing unique elements included in uniform resource identifiers in previously received requests for the content, and the second server is configured to verify the uniform resource identifier only if its unique element has not been previously received. This ensures that a given uniform resource indicator may only be verified once by the second server, limiting any possibility for the security of the second server to be breached if previous requests from the user have been intercepted by malicious third parties.

According to a third aspect of the present invention, there is provided an apparatus for delivering content to a user, the apparatus comprising:

a plurality of first servers, each first server being associated with a respective public/private key pair and configured to:
authenticate the user, and
sign an item of data using a private key of a public/private key pair with which the first server is associated; and

a second server configured to:
receive the signed item of data,
verify using the public key of the public/private key pair with which the first server is associated that the item of data was signed using the private key of the public/private key pair, and
deliver the content to the user only if the item of data is so verified.

According to a fourth aspect of the present invention, there is provided a method for delivering content to a user, the method comprising:

at a plurality of first servers, each being associated with a public/private key pair,
authenticating the user, and
signing an item of data using a private key of a public/private key pair with which the first server is associated; and

at a second server
receiving the signed item of data,
verifying using the public key of the public/private key pair with which the first server is associated that the item of data was signed using the private key of the public/private key pair, and
delivering the content to the user only if the item of data is so verified.

So, in the third and fourth aspects of the present invention, a user may be authenticated by a plurality of first servers in such a manner that a second server may verify the authentication and thereby provide content to the user. In this manner, the same second server may provide content to users registered with a range of first servers, without the second server having to authenticate these users directly. Accordingly, this allows first servers to securely offer content to their users, even when they do not control the content themselves.

Preferably, the content and/or additional content relate to a mobile site building service and/or the service is a/the mobile site building service. For example, the content and/or additional content may be a control panel for a mobile site building service, where the mobile site building service is effective to create a web site belonging to the user that is appropriate for viewing on a mobile communications device. The control panel can be manipulated by the user to optimise the mobile site building service.

The example of a mobile site building service is useful in illustrating the benefits of the present invention. In an exemplary scenario, an internet domain name registrar provides services to a user relating to that user's web resources. For example, the internet domain name registrar registers the internet domain name of the user's web resources. The internet domain name registrar also operates the first server. Most web resources are intended for use by desktop and laptop personal computers (PCs). This means they are often unsuitable for use by mobile communication devices. Web resources, typically websites and web pages, may include elements such as script, graphics, animations, video data, audio data, layouts etc. that are not supported by a mobile communication device. For example, a website may include Java® or Adobe® Flash object, but a mobile communication device may not have the correct software to use the object. Similarly, an image on a website may be too large to be displayed on a mobile communication device.

To address the above issue, the internet domain name registrar may wish to offer a mobile site building service to the user. The mobile site building service offers to build a site appropriate for use by mobile communication devices. For example, the mobile site building service may generate a mobile web resource according to the user's preferences. Therefore, by offering a mobile site building service to the user, the internet domain name registrar is offering a means for allowing the user to present mobile web resources for use by mobile communication devices.

In this example, the mobile site building service is controlled by a mobile site builder (MSB), which is a separate entity to the internet domain name registrar and operates the second server. The internet domain name registrar and the MSB have a relationship whereby users of the internet domain name registrar can build web resources that are suitable for use by mobile communication devices. This allows the internet domain name registrar to offer a mobile site building service to its users, but does not require a direct relationship between the MSB and those users.

Further, the MSB wishes to offer some customisation of the manner in which its mobile site building service operates. It does so by transmitting certain content, in this case a control panel, which can be manipulated as desired. The MSB wishes to offer the control panel to the owner of the web resources from which the mobile version is to be created, i.e. the internet domain name registrar's users. Moreover, the customisation must be secure to avoid any malicious interference with the mobile site building service. The present invention allows authentication of the users carried out at the first server operated by the internet domain name registrar to be relied upon by the second server operated by the TSP in delivering the control panel to the users. Accordingly, the requirement that the delivery of the control panel is secured is met without the need to the internet domain name registrar to share details of its users with the MSB, the MSB to hold details of all the internet domain name registrar's users, or the users to separately register themselves with the internet domain name registrar. As such, the present invention provides advantages to all three of the internet domain name registrar, the users, and the MSB.

Use of the words “system”, “server” and so on are intended to be general rather than specific. Whilst these features of the invention may be implemented using an individual component, such as a computer or a central processing unit (CPU), they can equally well be implemented using other suitable components or a combination of components. For example, the invention could be implemented using a hard-wired circuit or circuits, e.g. an integrated circuit, or using embedded software. It can also be appreciated that the invention can be implemented, at least in part, using computer program code. According to another aspect of the present invention, there is therefore provided computer software or computer program code adapted to carry out the method described above when processed by a computer processing means. The computer software or computer program code can be carried by computer readable medium. The medium may be a physical storage medium such as a Read Only Memory (ROM) chip. Alternatively, it may be a disk such as a Digital Video Disk (DVD-ROM) or Compact Disk (CD-ROM). It could also be a signal such as an electronic signal over wires, an optical signal or a radio signal such as to a satellite or the like. The invention also extends to a processor running the software or code, e.g. a computer configured to carry out the method described above.

A preferred embodiment of the invention is described below, by way of example only, with reference to the accompanying drawings.

### BRIEF DESCRIPTION OF THE DRAWINGS

FIG. 1 is a schematic illustration of an apparatus for providing a transcoding service; and

FIG. 2 is a sequence diagram illustrating the steps carried by the apparatus shown in FIG. 1.

### DETAILED DESCRIPTION OF THE PREFERRED EMBODIMENTS

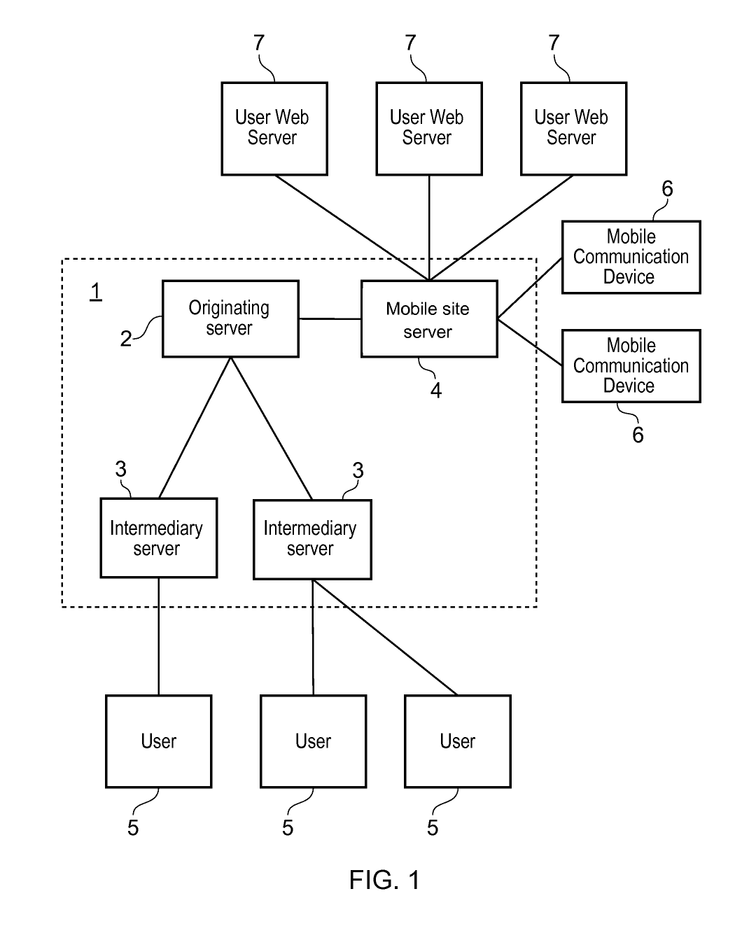

Referring to FIG. 1, an apparatus 1 for providing a mobile site building service comprises an originating server 2, a plurality of intermediary servers 3 and a mobile site server 4. The originating server 2 is illustrated as being coupled to the plurality of intermediary servers 3 and the mobile site server 4. Each intermediary server 3 is illustrated as being coupled to one or more users 5 and the mobile site server 4 is illustrated as being coupled to a plurality of mobile communication devices 6 and a plurality of user web servers 7. However, the apparatus 1 is illustrated in this way only for ease of presentation. In practice, the originating server 2, plurality of intermediary servers 3 and the mobile site server 4 communicate with one another over the internet. The coupling in FIG. 1 simply illustrates the exchange of data between the originating server 2, plurality of intermediary servers 3, the mobile site server 4, the one or more users 5, the plurality of mobile communication devices 6 and the plurality of user web servers 7 over the internet.

Reference to the “internet” is intended to include all communication networks capable of exchanging data using internet communication protocols. In particular, as well as the multitude of Wide Area Networks (WANs) commonly considered to make up the internet, it includes mobile communication networks and Local Area Networks (LANs). In another embodiment, the originating server 2 and the mobile site server 4 communicate with one another over a LAN that is not part of the internet, in that it is a private LAN separated from the internet, typically by a firewall.

The originating server 2, intermediary servers 3, mobile site server 4, users 5 and user web servers 7 are each data processing devices. In one embodiment, they are each separate computers. In particular, the users 5 each comprise a terminal, such as a Personal Computer (PC). More specifically, each user 5 is a PC running an internet browser under the control of a person. In another embodiment, two or more of originating server 2, intermediary servers 3, mobile site server 4, users 5 and user web servers 7 are implemented on a single data processing device. For example, it is the different identities of the persons that separate one user 5 from another user 5, and it is conceivable that two different persons could use the same PC, albeit at different times, and be considered to be two different users 5 for the purposes of the present description. Similarly, the originating server 2 and the mobile site server 4 may be implemented on a single computer.

In the preferred embodiment, the persons associated with each of the users 5 each own a website containing web resources suitable for use by PCs. In the preferred embodiment, the websites are each hosted at a respective one of the plurality of user web servers 7, although in other embodiments two or more of the websites are hosted at one of the user web servers 7 or one or more of the websites is hosted elsewhere, e.g. at an intermediary server 3 or a user 5.

The mobile site server 4 is configured to create mobile websites containing web resources suitable for use by mobile communication devices 6. The mobile websites may be associated with the existing websites containing web resources suitable for use by PCs. For example, a mobile website and an existing website may contain links to the same information regarding the users 5.

The mobile site server 4 is also configured to store the mobile websites. The mobile site server 4 is further configured to receive requests for the mobile websites from mobile communication devices 6 and to deliver the mobile websites in response to the requests.

In the preferred embodiment, the intermediary servers 3 are under the control of internet domain name registrars of first internet domain names by which the websites are identified. More specifically, the registrars are responsible for registering the first internet domain names at the appropriate internet domain name registry such that the IP addresses of the respective user web servers 7 at which the websites are hosted are associated with the first internet domain names in the Domain Name System (DNS) records of the internet. Also in the preferred embodiment, the originating server 2 is under the control of the internet domain name registry for second internet domain names by which the mobile communication devices 6 request mobile websites from the mobile site server 4 and the registrars controlling the intermediary servers 3 are also the internet domain name registrars for these second internet domain names.

So, by way of example, a person associated with one of the users 5 owns a website. The website is identified by a first internet domain name, e.g. “bobspizzashop.com”, for which the intermediary server 3 is the registrar. The website is hosted at one of the user web servers 7 and the IP address of that server is associated with the first internet domain name in the DNS records of the internet. The person associated with the user 5 is also the registrant of a second internet domain name, e.g. “bobspizzashop.mobi”, for which the intermediary server 3 is the registrar and the originating server 2 is the registry. The mobile site server 4 creates and hosts a mobile website identified by internet domain name “bobspizzashop.mobi” which may contain links to similar content as the website identified by internet domain name “bobspizzashop.com”.

The second internet domain names identify the mobile site server 4. More specifically, the registry for the second internet domain names registers the second internet domain names such that the IP address of the mobile site server 4 is associated with the second internet domain names in the DNS records of the internet. So, when one of the mobile communication devices 6 sends a request including a second internet domain name, the request is directed to the mobile site server 4. On receiving the request, the mobile site server 4 is configured to deliver the mobile website to the mobile communication device 6.

The apparatus 1 allows the user 5 to manage aspects of the creation of the mobile website carried out by the mobile site server 4. More specifically, the originating server 2 is configured to enable the users 5 to manage details such as particular elements to be incorporated into the mobile website by the mobile site building server 4. For example, the user 5 may wish to choose whether the mobile website includes elements such as a link to another website. This is achieved by the originating server 2 providing a web resource to the user 5 including links that allow the user 5 to send requests to the originating server 2 instructing it to alter its control of the mobile site building server 4. This web resource is referred to as a control panel.

In order to ensure that only the user 5 under the control of the person that is the registrant for a given second internet domain name is able to manage the creation of the mobile website by the mobile site server 4, it is important that the person is identified as registrant of the second internet domain name. As the intermediary servers 3 are under the control of the registrars of the second internet domain names, the intermediary servers 3 already have relationships with the persons that are the registrants of second internet domain names. These relationships can be used to authenticate the users 5. More specifically, when the relationship is established, a person that is a registrant of a second internet domain name registers their details with the registrar. In the preferred embodiment, this involves the user 5 providing information identifying the person controlling the user 5, such as a postal address, email address or payment card, to the intermediary server 3, along with a username and password. The intermediary server 3 verifies the identification information is genuine and that the username is unique. Once the identification information has been verified by the intermediary server 3 and provided the username is unique, the unique username and password are stored by the intermediary server 3 and remembered by the person. Then, at a later time, the user 5 can provide the unique username and password to the intermediary server 3 for authentication purposes.

Before the originating server 2 provides the control panel to the user 5, the intermediary server 3 authenticates the user 5 by providing a web page to the user 5 configured to allow the user 5 to provide a username and password to the intermediary server in an HTTP request. If the username and password provided by the user 5 in the HTTP request match a unique username and associated password stored by the intermediary server 3, the intermediary server can identify the person controlling the user 5 as the registrant of a second internet domain name. The user 5 is thereby authenticated. Although the preferred embodiment uses the combination of a username and password to authenticate the user 5, one skilled in the art will recognise that the user 5 could be authenticated using alternative techniques.

Each intermediary server 3 is associated with a different public/private key pair. More specifically, the intermediary server 3 is configured to generate a public/private key pair itself. In this embodiment, the private/public key pair is generated by the intermediary server 3 using a Rivest, Shamir and Adleman (RSA) algorithm, although other algorithms can be adopted as appropriate. The intermediary server 3 stores the private key of the public/private key pair it generates and provides the public key to the originating server 2

Based on the identity of the person controlling the user 5, the intermediary server 3 is configured to provide a link to the user 5. In the preferred embodiment, the link is provided as part of a new web page. The link comprises a Uniform Resource Identifier (URI) generated by the intermediary server 3 for identifying the control panel at the originating server 2. More specifically the URI comprises a Uniform Resource Locator (URL) which includes an identification of the originating server 2 and a parameter signed using a private key of the public/private key pair associated with the intermediary server 3. Signing the parameter, or content/data in general, using the private key means that at least part of it has been encoded using the private key. In more detail, the link includes the internet domain name identifying the originating server 2, an element identifying the intermediary server 3 and a digest. The digest is based on other elements, including an element identifying the second internet domain name for which the person controlling the authenticated user is the registrant and a unique parameter, such as the date and time of generation of the link, and encoded using the private key of the intermediary server. That is, the URI is signed by encoding the digest with the private key.

An exemplary URI may take the following form:

http://www.instantmobilizer.com/{registrar_id}/{domain_name}/{time}/{signature}/{language}.

In this URI, “www.instantmobilizer.com” identifies the originating server 2 ensuring that requests using the URI are directed to the originating server 2.

The “{registrar_id}” represents identification of the intermediary server 3, such as the registrar identification held by the Internet Corporation for Assigned Names and Numbers (ICANN), which allows the originating server 2 to identify the intermediary server 3 that generated the URI when receiving a request that uses it. This allows the originating server 2 to use the correct public key when decoding the “{signature}”.

The “{domain name}” may indicate one or both of the first internet domain name and the second internet domain name. This allows the originating server 3 to identify the web resource for which a control panel is requested.

The “{time}” indicates the time at which the URI was generated. As the URI depends in part upon the time at which it is generated, no two URI's are identical. This means that it is possible for the originating server 2 to verify a given URI only once.

The “{signature}” is the part of the URI that is encoded using the private key associated with the intermediary server 3 that generates the URI. In the preferred embodiment, a hash digest is generated based on the “{registrar_id}”, the “{domain_name}” and the “{time}” in the URI. This can be done using, for example, the SHA1 or MD5 algorithms known in the art. The hash digest is then encoded using the private key to create the “{signature}” and thereby sign the URI.

Once the intermediary server 3 has generated the URI, the intermediary server 3 delivers the web page, including the generated URI, to the user 5.

The user 5 is configured to render the web page on its internet browser when it receives the web page from the intermediary server 3. The person controlling user 5 can then select the link in the web page with which the URI is associated. When the link is selected, the user 5 sends an HTTP request based on the URI. The internet domain name in the URI identifies the originating server 2 and the request is therefore send to the originating server 2.

The originating server is configured to deliver the control panel to the user 5 in response to receiving the request. However, before it delivers the control panel to the user 5, the originating server 2 first identifies the intermediary server 3 from the appropriate element of the URI and decodes the digest using the public key of the identified intermediary server 3. The originating server 2 is only able to decode the digest if the digest was encoded using the private key of the identified intermediary server 3. If the originating server 3 is unable to decode the digest, it discards the request and does not provide a response.

From the decoded digest, the originating server 2 is able to identify the unique string. The originating server 2 is configured to compare the received unique string to unique strings previously received from the identified intermediary server 3 and stored at the originating server 2. If the received unique string is the same as any of the stored unique strings, the originating server 2 determines that the URI has been received before. Consequently, it discards the request and does not provide a response. So, if the request is intercepted by a third party and the third party attempts to use the request at a later time, the originating server 2 recognises that it is receiving the request for a second time and does not respond. Otherwise, the originating server 2 is configured to store the received unique string and proceed to generate the control panel.

From the decoded digest, the originating server 2 is also able to identify the second internet domain name to which URI relates. It can then generate a control panel appropriate for controlling transcoding by the mobile site server 4 in response to requests based on that second internet domain name. In the preferred embodiment, the control panel is delivered to the user 5 in an IFRAME of the web page delivered by the intermediary server 3 to the user 5. IFRAMEs are a technique that allows content such as the control panel to be embedded within an existing web page. Content within the IFRAME cannot interact with or affect the rest of the web page, while the rest of the web page cannot affect the content within the IFRAME. Not only does the user 5 therefore not have to separately authenticate itself with the originating server 2, but the user does not even need to navigate away from the web page provided by the intermediary server 3. The experience of the user 4 is therefore not compromised by the fact that it may receive services from two separate entities, the intermediary server 3 and the originating server 2.

Once the control panel has been delivered to the user 5, the person controlling the user 5 is able to interact with the control panel. This is done by the user selecting links in the control panel. These links generate requests to the originating server to control the creation of a mobile website carried out by the mobile site server 4 in relation to the second internet domain name for which the person controlling the user 5 is a registrant.

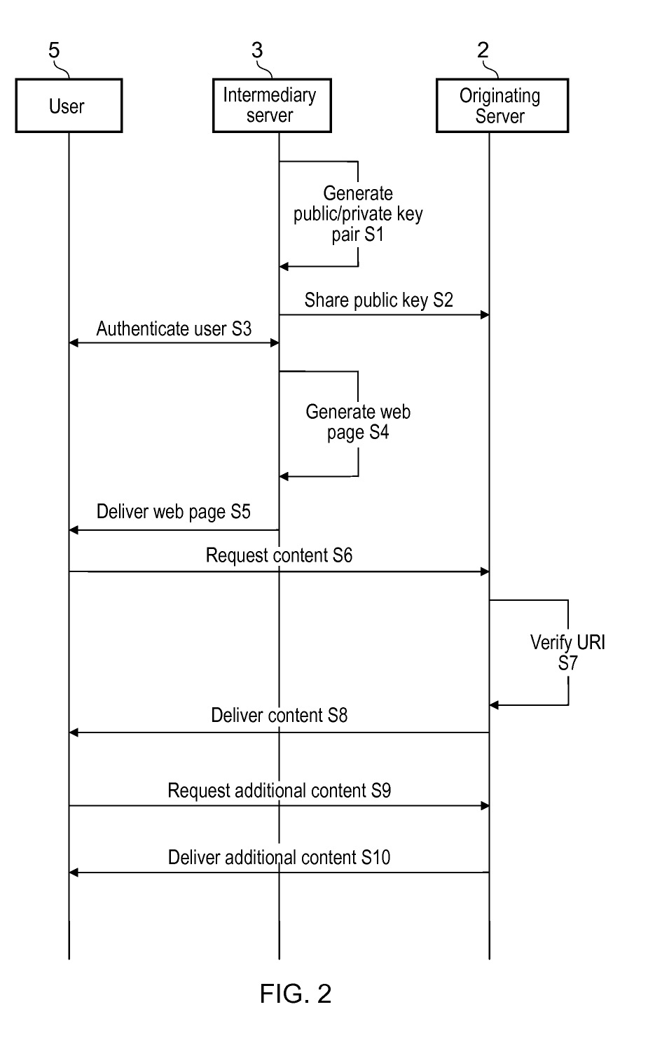

Referring to FIG. 2, in operation, at step S1, the intermediary server 3 generates a public/private key pair. In other words, it creates a public key and a private key that are associated with one another. The private key is kept confidential by the intermediary server 3, while the public key is provided to the originating server 2, at step S2. In other words, the intermediary server 3 shares the public key with the originating server 2.

At step S3, the intermediary server 3 authenticates the user 5. The person controlling the user 5 has previously registered with the registrar controlling the intermediary server 3. Authentication of the user 5 comprises the intermediary server delivering a web page to user 5. The person controlling the user 5 enters a username and password into the web page and the user 5 generates an HTTP request using the web page and based on the username and password entered by the person. The intermediary server 3 receives the HTTP request and compares the username and password received from the user 5 in the request to unique usernames and password stored at the intermediary server. If the username and password match a stored unique username and password, the person controlling the user 5 is identified and the user 5 is consequently authenticated. If no match is found, the user 5 is not authenticated and the intermediary server delivers a web page again asking for a username and password.

If the user 5 is authenticated, at step S4, the intermediary server 3 generates the web page and delivers it to the user 5. The web page includes the Uniform Resource Identifier (URI). If the person controlling the user 5 desires to view the control panel, the person selects the link in the web page can the user 5 generates an HTTP request including the URI. This causes the URI to be transmitted from the user 5 to the originating server 2 across the internet at step S6.

On receiving the URI, at step S7 the originating server 2 identifies the intermediary server 3 that generated the URI and decodes the digest using the public key of the identified intermediary server 3. This allows the originating server 2 to verify that the link was in fact generated using the private key. In this manner, the originating server 2 can verify that the user 5 has authenticated themselves with the intermediary server 3.

In the preferred embodiment, the originating server 2 is arranged to only verify a particular link once. That is, if the originating server 2 receives the same link a second time then it will not verify the link and will not proceed to step 8 below. This ensures that even if an unauthorised party becomes aware of a validly generated link previously transmitted to the originating server 2 from the user 5, it will not be able to use this to request the control panel from the originating server 2. The user 5 is not disadvantaged by this, as each time the user 5 authenticates itself with the intermediary server 3 a new, valid link is generated by the intermediary server 3 using the private key.

If the link is verified by the originating server 2, the originating then delivers the control panel to the user 5, at step S8. Since the delivery of the control panel only occurs if the originating server 2 verifies that the link was generated by the intermediary server 3, and the link is only generated by the intermediary server 3 after it has authenticated the user 5, the effect is that the originating server 2 relying on authentication of the user carried out by the intermediary server 3. There is no need for the originating server 2 to authenticate the user 5 itself.

The described embodiments of the invention are only examples of how the invention may be implemented. Modifications, variations and changes to the described embodiments will occur to those having appropriate skills and knowledge. These modifications, variations and changes may be made without departure from the scope of the invention defined in the claims and its equivalents.

1. Apparatus for delivering content to a user, the apparatus comprising:
a first server configured to
authenticate the user,
receive a request from the user for a web resource,
generate a uniform resource identifier, at least part of which is signed using a private key of a public/private key pair, and
deliver the web resource to the user, the web resource including the uniform resource identifier; and
a second server configured to
receive a request from the user for the content, the request including the uniform resource identifier,
verify using the public key of the public/private key pair that the at least part of the uniform resource identifier was signed using the private key of the public/private key pair, and
deliver the content to the user in response to the request only if the uniform resource identifier is so verified.

2. Apparatus according to claim 1, wherein the web resource comprises a web page and the content is delivered to the user as part of the web page.

3. Apparatus according to claim 1, wherein the content delivered to the user includes an additional uniform resource identifier and the second server is configured to
receive an additional request from the user for additional content, the additional request including the additional uniform resource identifier, and
deliver the additional content to the user in response to the additional request.

4. Apparatus according to claim 1, wherein the content delivered to the user includes an additional uniform resource identifier and the second server is configured to
receive an additional request from the user relating to a service controlled by the second server, the additional request including the additional uniform resource identifier, and
alter control of the service in response to the additional request.

5. Apparatus according to claim 1, additionally for delivering the content to another user, the apparatus comprising
one or more additional first servers, each additional first server being associated with a respective public/private key pair and configured to
authenticate the other user,
receive a request from the other user for a web resource,
generate a uniform resource identifier, at least part of which is signed using the private key of a public/private key pair with which the additional first server is associated, and
deliver the web resource to the other user, the web resource including the uniform resource identifier; and
a second server configured to
receive a request from the other user for the content, the request including the uniform resource identifier,
verify using the public key of the public/private key pair with which the additional first server is associated that the at least part of the uniform resource identifier was signed using the private key of the public/private key pair, and
deliver the content to the other user in response to the request only if the uniform resource identifier is so verified.

6. Apparatus according to claim 1, wherein the uniform resource identifier includes a unique element and the second server comprises a memory for storing unique elements included in uniform resource identifiers in previously received requests for the content, and the second server is configured to verify the uniform resource identifier only if its unique element has not been previously received.

7. Apparatus for delivering content to a user, the apparatus comprising:
a plurality of first servers, each first server being associated with a respective public/private key pair and configured to:
authenticate the user, and
sign an item of data using a private key of a public/private key pair with which the first server is associated; and
a second server configured to:
receive the signed item of data,
verify using the public key of the public/private key pair with which the first server is associated that the item of data was signed using the private key of the public/private key pair, and
deliver the content to the user only if the item of data is so verified.

8. Apparatus according to claim 7, wherein the content and/or additional content relate to a mobile site building service and/or the service is a/the mobile site building service.

9. A method of delivering content to a user, the method comprising:
at a first server
authenticating the user,
receiving a request from the user for a web resource,
generating a uniform resource identifier, at least part of which is signed using a private key of a public/private key pair, and
delivering the web resource to the user, the web resource including the uniform resource identifier; and
at a second server
receiving a request from the user for the content, the request including the uniform resource identifier,
verifying using the public key of the public/private key pair that the at least part of the uniform resource identifier was signed using the private key of the public/private key pair, and
delivering the content to the user in response to the request only if the uniform resource identifier is so verified.

10. A method according to claim 9, wherein the web resource comprises a web page and the content is delivered to the user as part of the web page.

11. A method according to claim 9, wherein the content delivered to the user includes an additional uniform resource identifier and the method comprises, at the second server
receiving an additional request from the user for additional content, the additional request including the additional uniform resource identifier, and
delivering the additional content to the user in response to the additional request.

12. A method according to claim 9, wherein the content delivered to the user includes an additional uniform resource identifier and the method comprises, at the second server
receiving an additional request from the user relating to a service controlled by the second server, the additional request including the additional uniform resource identifier, and
altering control the service in response to the additional request.

13. A method according to claim 9 additionally for delivering the content to another user, comprising
at one or more additional first servers, each being associated with a respective public/private key pair,
authenticating the other user,
receiving a request from the other user for a web resource,
generating a uniform resource identifier, at least in part of which is signed using the private key of a public/private key pair with which the additional first server is associated, and
delivering the web resource to the other user, the web resource including the uniform resource identifier; and
at the second server
receiving a request from the other user for the content, the request including the uniform resource identifier,
verifying using the public key of the public/private key pair with which the additional first server is associated that the at least part of the uniform resource identifier was signed using the private key of the public/private key pair, and
delivering the content to the other user in response to the request only if the uniform resource identifier is so verified.

14. A method according to claim 9, wherein the uniform resource identifier includes a unique element and the method further comprises, at the second server, storing the unique element included in the uniform resource identifier, wherein the uniform resource identifier is verified only if its unique element has not been previously received.

15. A method for delivering content to a user, the method comprising:
at a plurality of first servers, each being associated with a public/private key pair,
authenticating the user, and
signing an item of data using a private key of a public/private key pair with which the first server is associated; and
at a second server
receiving the signed item of data,
verifying using the public key of the public/private key pair with which the first server is associated that the item of data was signed using the private key of the public/private key pair, and
delivering the content to the user only if the item of data is so verified.

16. A method according to claim 15, wherein the content and/or additional content relate to a mobile site building service and/or the service is a/the mobile site building service.

17. Computer software for carrying out a method according to claim 9 when processed by computer processing means.

18. Computer software for carrying out a method according to claim 15 when processed by computer processing means.

19. Apparatus according to claim 2, additionally for delivering the content to another user, the apparatus comprising
one or more additional first servers, each additional first server being associated with a respective public/private key pair and configured to
authenticate the other user,
receive a request from the other user for a web resource,
generate a uniform resource identifier, at least part of which is signed using the private key of a public/private key pair with which the additional first server is associated, and
deliver the web resource to the other user, the web resource including the uniform resource identifier; and
a second server configured to
receive a request from the other user for the content, the request including the uniform resource identifier,
verify using the public key of the public/private key pair with which the additional first server is associated that the at least part of the uniform resource identifier was signed using the private key of the public/private key pair, and deliver the content to the other user in response to the request only if the uniform resource identifier is so verified.

20. Apparatus according to claim 3, additionally for delivering the content to another user, the apparatus comprising
one or more additional first servers, each additional first server being associated with a respective public/private key pair and configured to
authenticate the other user,
receive a request from the other user for a web resource,
generate a uniform resource identifier, at least part of which is signed using the private key of a public/private key pair with which the additional first server is associated, and
deliver the web resource to the other user, the web resource including the uniform resource identifier; and
a second server configured to
receive a request from the other user for the content, the request including the uniform resource identifier,
verify using the public key of the public/private key pair with which the additional first server is associated that the at least part of the uniform resource identifier was signed using the private key of the public/private key pair, and
deliver the content to the other user in response to the request only if the uniform resource identifier is so verified.
